(19) United States
(12) Patent Application Publication
(10) Pub. No.: US 2004/0105539 A1
(43) Pub. Date: Jun. 3, 2004

(54) High-speed data transmission system to a digital terminal

(76) Inventors: Jean-Marc Auzizeau, Rospez (FR); Gerard Terol, Louannec (FR)

Correspondence Address: Thomas Langer, Cohen Pontani Lieberman & Pavane, Suite 1210, 551 Fifth Avenue, New York, NY, 10176, US

(21) Appl. No.: 10/473,622

(22) PCT Filed: Apr. 2, 2002
(86) PCT No.: PCT/FR02/01128

(30) Foreign Application Priority Data
Apr. 5, 2001 (FR) 01/04762

(51) Int. Cl. H04M 7/04; H04M 9/00; H04M 1/00

(52) U.S. Cl. 379/398; 379/399.01

(57) ABSTRACT

A system for transmitting information at high speed to a subscriber's digital terminal (30). According to the invention, said system comprises at least passive adapter means (10, 10′) between an xDSL link (1) for high speed transmission of information and a mains voltage electricity network (2) having at least said subscriber's digital terminal (30) connected thereto. The invention is applicable to high speed transmission over the terminal portion of a subscriber line.

The present invention relates to a system for transmitting information at high speed to a digital terminal.

An advantageous application of the invention lies in the field of transmitting information at high speed over the terminal portion of the subscriber line and via the subscriber's mains voltage electricity network.

Systems are already known for transmitting information over a subscriber terminal connection by means of the subscriber's mains voltage electricity network, however those systems require the information for transmission to be treated. The information is treated by installing two modem-type devices. One of the modem devices is located at the entry of the subscriber's electricity network close to where the information is received. Another modem device is disposed at the input to the terminal used by the subscriber to make use of the transmitted information. Said modem devices make use of specific “power line telecommunications” (PLT) modulation where the information is received followed by PLT demodulation of said information after it has traveled over the subscriber's electricity network. Such specific PLT modulation enables information to be transmitted over a frequency band that is different from that of the mains voltage electricity network.

Existing systems can operate only by adding said PLT modem devices to the electricity network, i.e. they require additional equipment that is specific to transmission of this type over the mains voltage electricity network.

Installing such PLT modem devices gives rise to additional costs. So far as the subscriber is concerned, two modem devices, serving to modulate and to demodulate information, represent considerable cost, which restricts the use of said systems for transmitting information over the mains voltage electricity network.

The technical problem to be solved by the present invention is to provide a high speed information transmission system which remedies the drawbacks of existing systems by enabling the subscriber to make a connection to a mains voltage electricity network while not installing expensive devices on said subscriber's electricity network.

According to the present invention, the solution to the technical problem posed consists in that said transmission system comprises at least passive adapter means between an xDSL link for transmitting information at high speed and a mains voltage electricity network to which at least said subscriber digital terminal is connected.

Thus, the high speed information transmission of the system avoids installing said PLT modem devices that have been required in the past for transmitting information over a mains voltage electricity network. Specific PLT modulation and demodulation are no longer used for transmitting said information over the mains voltage electricity network. Said passive adapter means replace the PLT modem devices used in existing transmission systems.

xDSL technology, where “DSL” stands for digital subscriber line, is a technique for transmitting information at high speed over a subscriber's digital line. The acronym xDSL is generally used to cover all such technology families, such as, for example, VDSL, HDSL, SDSL, ADSL, ADSL-lite, technologies.

xDSL transmission relies on associating on high performance modulation, encoding, multiplexing, error correcting, and filtering techniques. xDSL technology makes it possible to transmit various high speed services over the subscriber line, for example services to sites connected to the Internet, services for telephone conversation via the Internet (so-called “voice on IP” or “VoIP” services), and services for interactive transmission of video on demand (so-called “VoD” services).

An xDSL connection is made up of a modem device installed in the distribution network of telecommunications services. This first modem device acts in the network to perform the modulation for the xDSL link. Another xDSL modem device is installed in the subscriber installation. This second modem device serves to perform demodulation going to a subscriber digital terminal. It enables the subscriber to access various high speed services.

According to the invention, said passive adapter means are disposed firstly at the entry to the mains voltage electricity network, and secondly at the entry to said digital terminal.

In this way, said transmission system makes it possible to use a mains voltage electricity network that is generally already in existence in all buildings, with numerous access points within the premises. This makes it possible to reach all potential users of telecommunications services. This also enables the subscriber to connect freely to any point of the mains voltage electricity network via standard electrical outlets or “receptacles”, thus avoiding the need for special cabling to transmit said telecommunications services.

In addition, said high speed information transmission system of the invention is suitable for conveying xDSL modulation over the mains voltage electricity network to the digital terminal because of said passive adapter means.

As a result, the electricity network is very simple to use in a high speed transmission system making use of an xDSL link.

It should be observed that said high speed information transmission system of the invention is suitable for transmitting said information directly because of said passive adapter means. Said passive adapter means of the system are respective passive circuits without any active components. Such a passive circuit, which does not perform any processing of the information, also explains how it is that compatibility can be achieved with all xDSL technologies.

Said passive adapter circuit associated with said transmission system of the invention comprises at least low frequency filter means on the mains voltage electricity network and means for providing isolation between said mains voltage electricity network and the xDSL link.

Said passive matching device of the invention is of very simple design. It is therefore inexpensive, unlike PLT modem devices. As a result, a large quantity of subscribers can access high speed services, for example Internet services, which until now has been available only to subscribers possessing expensive PLT modem devices or else special cabling for carrying said telecommunications services.

The following description with reference to the accompanying drawings, given as non-limiting examples, show what the invention consists in and how it can be implemented.

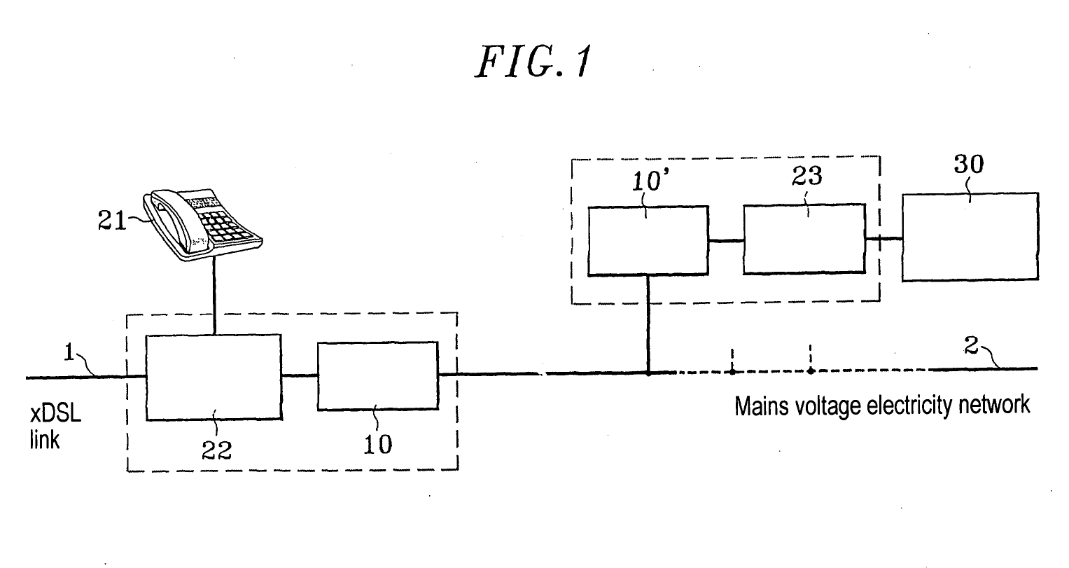

FIG. 1 is a block diagram of a transmission system in accordance with the invention.

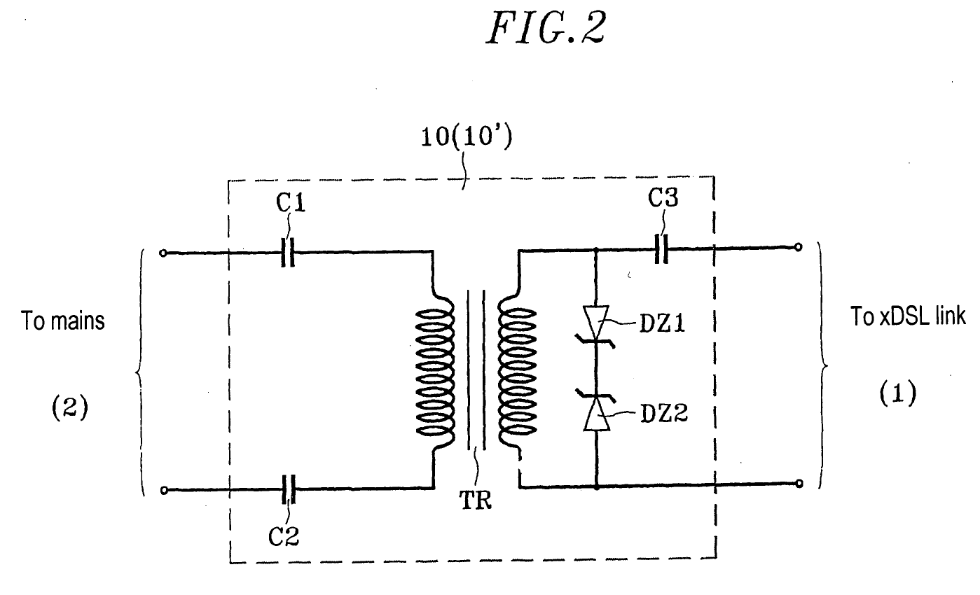

FIG. 2 is a detailed circuit diagram of a passive adapter device.

A subscriber seeking to access services that require high speed transmission of information is connected to a link 1 of the xDSL type. As mentioned above, this link transmits information that is modulated by the telecommunications services distributor. The system for high speed transmission to a subscriber digital terminal 30 in accordance with the invention is shown overall in FIG. 1.

If the subscriber continues to use a telephone set 21 for making voice calls, the telephone set is connected to a separator filter 22 which separates voice signals from xDSL modulated information.

In order to make it possible for the subscriber's mains voltage electricity network 2 to convey the information for transmission, a passive adapter device 10 is placed on the xDSL modulated link 1 after the separator filter 22 for receiving the information that is to be transmitting.

Unlike existing systems, said information transported by the electricity network continues to be modulated in xDSL. In exiting systems, the information for transmission is processed by so-called PLT modem devices which modulate and demodulate said information so as to distinguish it from mains electricity. This requires xDSL demodulation as soon as said information is received, in order to change the type of modulation and demodulation by using specific PLT technology for conveying information over the mains voltage electricity network.

Said passive adapter device 10 is either a small unit added to the installation, or else it is incorporated in the separator filter 22. Incorporation in the separator filter can easily be performed, given the simplicity of said passive adapter device 10 which is shown in detail in FIG. 2.

The connection between the passive adapter device 10 and the subscriber's electricity network takes place via a standard electrical receptacle.

Similarly, close to the digital terminal 30 of the subscriber, the passive adapter device 10′ is connected to the subscriber's electricity network via any standard electricity receptacle.

Furthermore, in order to simplify the installation further, the passive adapter device 10′ is completely identical with the passive adapter device 10 used where the xDSL modulated link 1 arrives.

Said passive adapter device 10′ is placed ahead of the xDSL modem device 23. It is the xDSL modem device 23 that demodulates the information that has been transmitted.

In the same manner as for the separator filter, said passive adapter device 10′ is either a small unit added to the installation, or else it is incorporated in the xDSL modem device 23. Since said passive adapter devices 10 and 10′ are identical and very simple, it is the incorporation solution that can again be provided very easily.

Said information is then forwarded to a subscriber's digital terminal 30. Depending on the type of information concerned, the subscriber's digital terminal may, for example, be a personal computer (PC) type terminal, or it may be a television (TV) digital decoder, or any other suitable digital terminal.

There follows a detailed description of said passive adapter device 10, 10′ which serves to isolate the electrical signal both from the separator filter 22 and thus the telephone line including the telephone set 21, and from the xDSL modem device 23, while still allowing information that has been modulated for high speed xDSL transmission to pass through.

Both passive adapter devices 10, 10′ are identical at their entry to the mains voltage electricity network 2 and where they connect towards the subscriber's digital terminal 30.

With reference to FIG. 2, the filter means C1, C2 of said passive adapter device 10, 10′ comprise two capacitors C1, C2 which eliminate the low frequencies of the electricity network. These two capacitors pass the information for transmission which is xDSL modulated at higher frequencies.

The isolating means TR comprise a transformer serving to match impedance between the mains voltage electricity network 2 and the xDSL modulated link 1.

It also serves to provide electrical isolation, preventing mains electricity from reaching the subscriber side in the event of a failure in the filter capacitors C1, C2. Such electrical isolation provides safety to the subscriber and is a legal requirement for all equipment connected to the electricity network and used by the general public.

The limiter means DZ1 and DZ2 are two zener diodes that eliminate all noise peak signals above the threshold levels of said zener diodes. These noise peak signals, also known as “transients”, are commonly encountered on an electricity network.

The matching means C3 comprise a capacitor for matching impedance between the xDSL modulated link 1 and the telephone set 21.

If no telephone set 21 is used for setting up voice calls, the capacitor C3 is omitted from said passive adapter devices 10, 10′.

As mentioned in the description, after detailed examination, it can be seen that said adapter device 10, 101 is a passive circuit without any active components. It does not perform any kind of processing on the information for transmission.

As a result, said passive adapter device 10, 10′ does not add error to the xDSL transmission, and it imparts little attenuation to the level of the information for transmission.

As mentioned above, the simplicity of the circuit and the small number of components contained in said passive adapter devices 10 and 10′ make it easy for them to be implanted either in the separator filter 22 where information is received, or in the xDSL modem device close to the subscriber's digital terminal 30.

1. A system for transmitting information at high speed to a subscriber's digital terminal (30), characterized in that said system includes at least passive adapter means (10, 10′) between an xDSL link (1) for transmitting information at high speed and a mains voltage electricity network (2) to which at least said subscriber's digital terminal (30) is connected.

2. A transmission system according to claim 1, characterized in that said passive adapter means (10, 10′) are disposed firstly on input to the mains voltage electricity network (2), and secondly at the input to said digital terminal (30).

3. A transmission system according to claim 1 or claim 2, characterized in that said system is suitable for transporting xDSL modulation over the mains voltage electricity network (2) to the digital terminal (30) via said passive adapter means (10, 10′).

4. A high speed transmission system according to any one of claims 1 to 3, characterized in that said system is suitable for transmitting said information directly via said passive adapter means (10, 10′).

5. A passive adapter device (10, 10′) configured for being associated with the transmission system of any one of claims 1 to 4, the device being characterized in that it comprises at least:
low frequency filter means (C1, C2) on the mains voltage electricity network (2); and
isolator means (TR) between the mains voltage electricity network (2) and the xDSL link (1).

6. A passive adapter device (10, 10′) according to claim 5, characterized in that said device (10, 10′) includes matching means (C3) for matching impedance to a telephone set (21).
